(19) United States
(12) Patent Application Publication
(10) Pub. No.: US 2019/0325512 A1
(43) Pub. Date: Oct. 24, 2019

(54) Using a Distributed Ledger for Tracking Debt Data

(71) Applicant: Diebold Nixdorf, Incorporated, North Canton, OH (US)

(72) Inventors: Devon Watson, North Canton, OH (US); Gary A. Ganger, Uniontown, OH (US); Gregory Shimek, Akron, OH (US); Vanessa Gagnon, Stow, OH (US); Douglas Kurt HARTUNG, Kingwood, TX (US)

(21) Appl. No.: 16/310,467

(22) PCT Filed: Jul. 14, 2017
(86) PCT No.: PCT/US17/42075

§ 371 Date: Dec. 17, 2018

Related U.S. Application Data
(60) Provisional application No. 62/362,378, filed on Jul. 14, 2016.
(60) Provisional application No. 62/429,416, filed on Dec. 2, 2016.
(60) Provisional application No. 62/431,150, filed on Dec. 7, 2016.
(60) Provisional application No. 62/440,489, filed on Dec. 30, 2016.
(60) Provisional application No. 62/440,492, filed on Dec. 30, 2016.

(51) Int. Cl. G06Q 40/02; G06F 16/182; H04L 9/06; H04L 9/08

(52) U.S. Cl. CPC G06Q 40/025; H04L 9/0838; H04L 9/0637; G06F 16/182

(57) ABSTRACT

In an example embodiment described herein, there is disclosed a method for using a distributed ledger (e.g., a blockchain) for tracking debt information. For example, debt data is created by a first financial institution responsive to a loan. The debt data is stored in a distributed ledger by the first financial institution with a first key that is associated with the first financial institution. Payment data is also stored in the distributed ledger encrypted by the first key. Upon transfer of the debt to a second financial institution, subsequent debt data is stored in the distributed ledger encrypted by a second key associated with the second financial institution.

### CROSS REFERENCE TO RELATED APPLICATIONS

This application claims the benefit under 35 U.S.C. § 119 of U.S. Provisional Applications Nos. 62/362,378, filed Jul. 14, 2016; 62/431,150 filed on Dec. 7, 2016; 62/440,489 filed on Dec. 30, 2016; 62/440,492 filed on Dec. 30, 2016; and 62/429,416 filed on Dec. 2, 2016. The contents of the aforementioned applications are hereby incorporated by reference herein in their entirety.

### TECHNICAL FIELD

The present disclosure relates generally to tracking debt information.

### BACKGROUND

In recent years, serious concerns have been raised about the sufficiency and accuracy of the information that debt buyers have at all stages of the collection process. Consumer groups have said that debt buyers typically receive from debt sellers at the time of sale only an electronic spreadsheet containing minimal information about debts and debtors. They also have charged that debt buyers often do little or nothing to verify debts if consumers dispute their validity—that is, they do not conduct an adequate investigation of consumer claims that they are not the debtor or that the amount of the debt being collected is incorrect.

### BRIEF DESCRIPTION OF THE DRAWINGS

The accompanying drawings incorporated herein and forming a part of the specification illustrate the example embodiments.

FIG. 1 is a block diagram of a system that employs a distributed ledger for tracking debt data.

FIG. 2 is an example of the system in FIG. 1 with additional financial institutions.

FIG. 3 is an example of the system of FIG. 1 further illustrating the distributed ledger and blocks in the distributed ledger for tracking debt data.

FIG. 4 is another example of a system that uses a distributed ledger for tracking debt data that illustrates an example of a sequence that employs three financial institutions.

FIG. 5 is an example of a computer system employed for implementing an example embodiment.

FIG. 6 is an example of a methodology for using a distributed ledger for tracking debt data.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, a method for using a distributed ledger (e.g., a blockchain) for tracking debt information. For example, debt data is created by a first financial institution responsive to a loan. The debt data is stored in a distributed ledger by the first financial institution with a first key that is associated with the first financial institution. Payment data is also stored in the distributed ledger encrypted by the first key. Upon transfer of the debt to a second financial institution, subsequent debt data is stored in the distributed ledger encrypted by a second key associated with the second financial institution. Other embodiments are directed to a system and a computer readable medium of instructions for execution by a processor that implement the method.

### Description of Example Embodiments

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

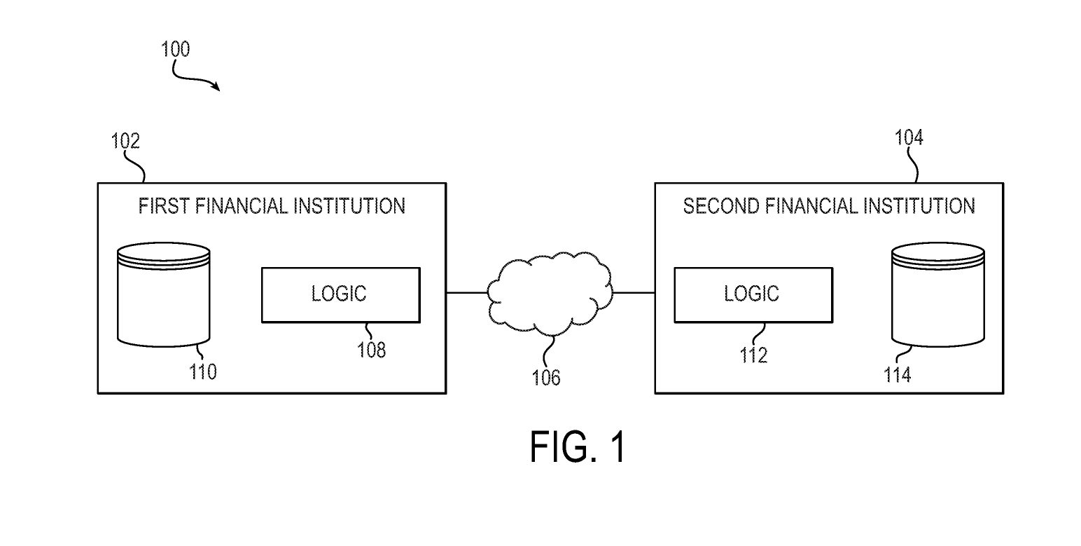

FIG. 1 is a block diagram of a system 100 that employs a distributed ledger for tracking debt data. The system 100 comprises a first financial intuition system 102 and a second financial institution system 104 that are coupled by a network 106. Network 106 may suitably comprise one or more wired or wireless networks, or a combination of wired and wireless networks.

The first financial institution system 102 comprises logic 108 for implementing the functionality described herein for the first financial institution. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that performs the desired functionality when executed by a processor. The first financial institution further comprises a data store 110.

The second financial institution system 104 comprises logic 112 for implementing the functionality described herein. The second financial institution further comprises a data store 112.

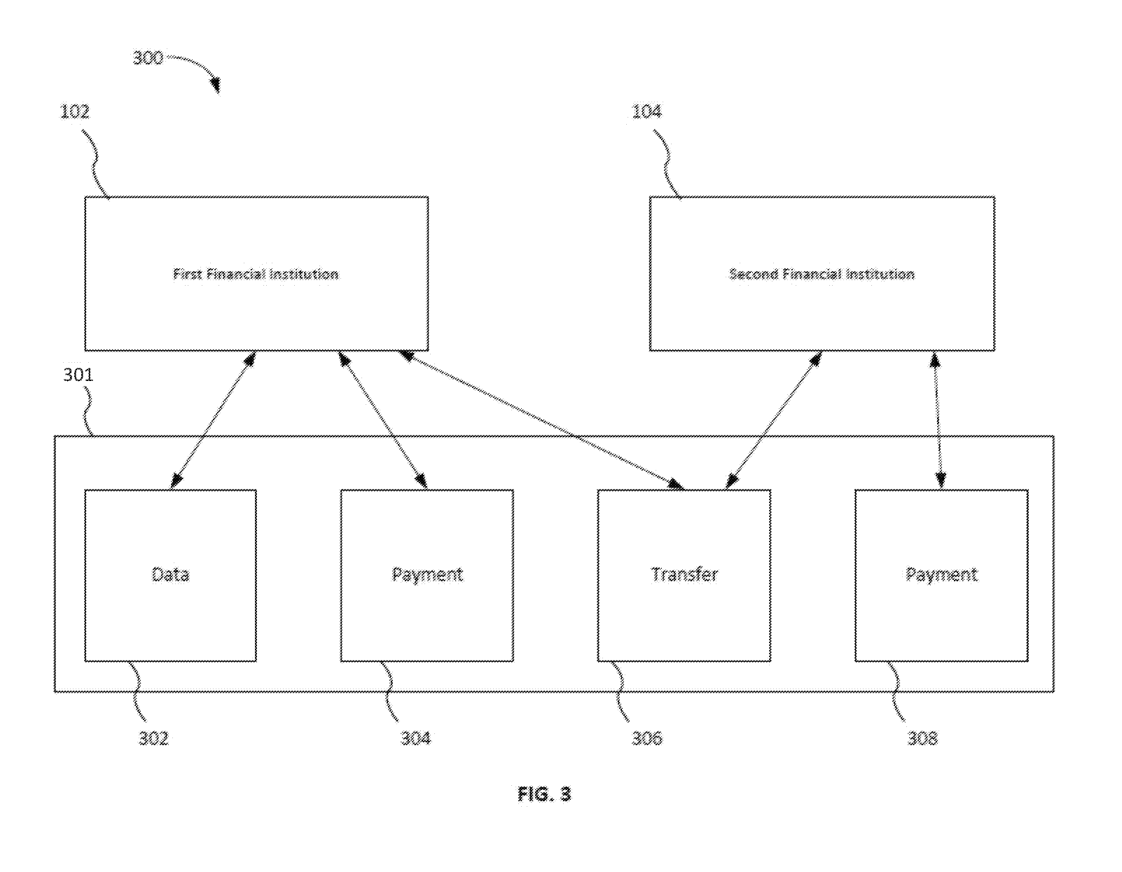

In an example embodiment, the first and second systems 102, 104 employ a distributed ledger (not shown, see e.g., Ref #301 in FIG. 3), such as a blockchain. The system 102 for the first financial institution 102 employs logic 108 for interacting with the distributed ledger and a data store 110 that may store at least a portion of the distributed ledger. The computer system for the second financial institution 104 employs logic 112 for interacting with the distributed ledger and a data store 114 that may store at least a portion of the distributed ledger. Logic 108 and logic 112 are operable to employ network 106 for interacting with portions of the distributed ledger.

In an example embodiment, the logic 108 for a first of the plurality of financial institutions is operable to receiving data representative of a debt. The data may be received from the financial institution's loan department or from any node coupled with the financial institution's network (e.g., a payday loan that is initiated at an automated banking machine such as an Automated Teller Machine or ATM).

The logic 108 for the first of the plurality of financial institutions is operable to store the data representative of the debt in a first block in the distributed ledger (now shown, see e.g., Ref. #302 I FIG. 3). The data representative of the debt is encrypted with a first key associated with the first financial institution.

The data representative of a debt may be for any type of debt, including but not limited to Mortgages, Home Equity Loans, Vehicle Loans, Personal Loans, or Payday loans. The data representative of a debt may comprise data representative of an owner of the debt. In another example embodiment, the debt data may comprise data representative of a debtor. In yet another example embodiment, the data representative of a debt comprises a debt balance data. In still yet another example embodiment, the data representative of a debt comprises terms of the debt (e.g., interest rate, period, number of payments). In another example embodiment, the data representative of a debt comprises payment history data for the debt. In still yet another example embodiment, the data representative comprises status data, such as, for example, whether payments for the debt are current (no overdue payments), overdue, or severely overdue (e.g., longer than a predetermined time period where some action should be taken, such as sending a overdue notice to the debtor, charge an overdue fee, or initiate other collection activity). In particular embodiments, the debt data may comprise any combination of data representative of the owner of the debt, the debtor, debt balance data, terms of the debt, payment history data for the debt, or status data.

As payments are received for the debt, logic 108 is operable to receive and store payment data (or data representative of a payment) into the distributed logic. For example, data representative of a first payment may be stored in a second block of the distributed ledger by logic 108. Payments stored by logic 108 are encrypted by a first key associated with the first financial institution to limit access to the payment data. In an example embodiment, the data representative of the payment further comprises updated data representative of the debt. The updated data representative of the debt include, but is not limited to, current payment history, current balance, and/or any other data associated with the debt such as current debt owner.

At some point in time while a debt is still outstanding, the debt may be transferred to another financial institution. For example, the debt may be purchased by a second financial institution. Upon transfer of the debt, data representative of the transfer may be stored in a third block of the distributed ledger. The data representative of the transfer may include, but is not limited to data representative of the current debt owner (the second financial institution in this example), current balance, original balance, prior debt owner, and payment history, and current status of the debt (e.g., current, overdue, severely overdue, for example in collections).

In an example embodiment, the data representative of the transfer is encrypted by a key shared by both logic 108 and logic 112 allowing either of the financial institutions view to the data stored in the third block. In particular embodiments, the data representative of the transfer is signed by both the first financial institution and the second financial institution to verify the transfer.

After transfer of the debt, payments may be made to the second financial institution. For example, the logic 112 for the second financial institution is operable to receive data representative of a second payment. The logic 112 for the second financial institution stores the data representative of the second payment in a fourth block of the distributed ledger, the data representative of the second payment is encrypted with a key associated with the second financial institution. In particular embodiments, the data stored in the fourth block may further comprise other debt data as described herein.

In an example embodiment, logic 108 and logic 112 further comprise logic for verifying the data indicating the transfer of the debt from the first financial institution to the second financial institution. The logic for verifying the data indicating the transfer of the debt from the first financial institution to the second financial institution is operable to verify that the data indicating the transfer of the debt from the first financial institution to the second financial institution was signed by the first financial institution and the second financial institution.

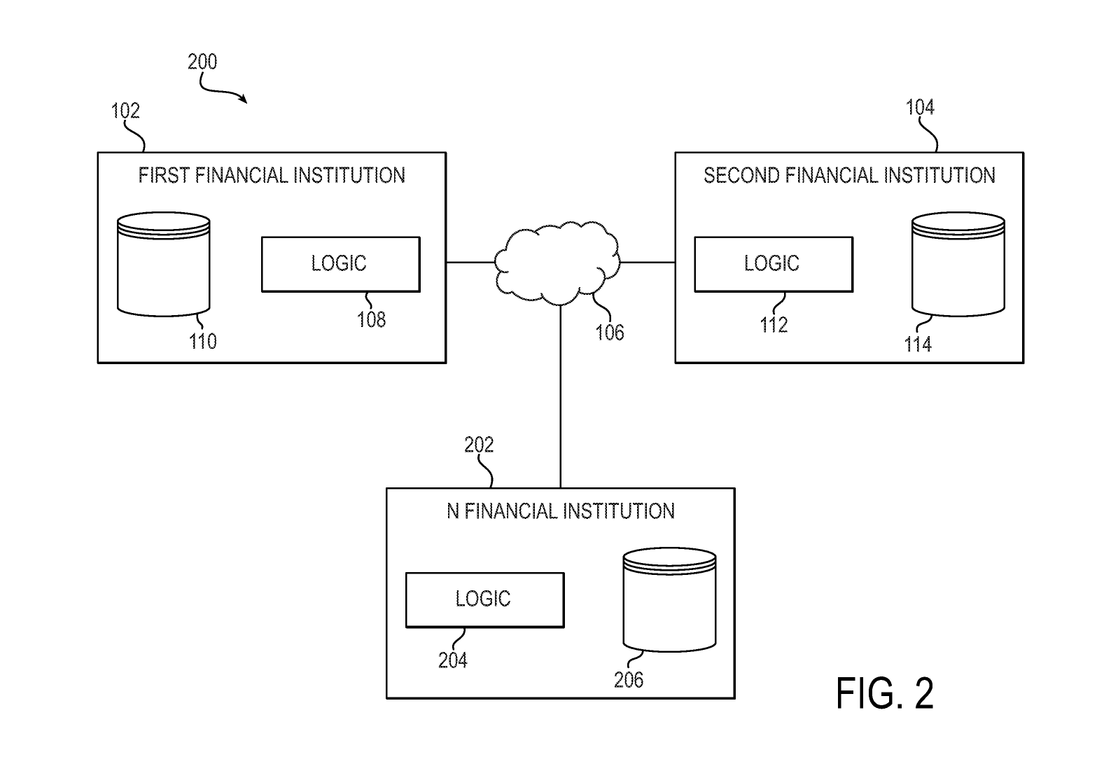

FIG. 2 is an example of the system in FIG. 1 with additional financial institutions. The system 200 comprises N financial institutions, where N is an integer greater than 2. The system for the nth financial institution is represented by system 202 which comprises logic 204 for interacting with the distributed ledger as described herein and data storage 206 that stores at least a portion of the distributed ledger.

FIG. 3 is an example of a system 300 that includes the system of FIG. 1 and further illustrates blocks in a distributed ledger 301 for tracking debt data. Referring to the example provided herein supra for the operation of the system in FIG. 1, block 302 represents the first block in the distributed ledger 301 that contains the initial debt data. As described herein, data in the first block may include, but is not limited to, data representative of debt owner, debtor, debt terms, such as amount, payment schedule and interest rate.

Block 304 represents payment data stored by the first financial institution's system 102 into distribution ledger 301. This date may include amount of payment, date of payment. In particular embodiments, other debt information may be included such as current debt owner, current balance, current debt status, and any other debt data. The data in block 304 is encrypted by a key associated with the first financial institution.

Block 306 represents the third block described above which comprises data representative of the transfer from the first financial institution to the second financial institution. In the illustrated example, block 306 is encrypted by a key that is shared by both the first financial institution and the second financial institution, allowing either one of them to view the data in block 306. In an example embodiment, the data in block 306 is signed by both the first financial institution and the second financial institution.

Block 308, represents payment data received by the second financial institution (or the fourth block in the above example). Block 308 is encrypted by a key associated with the second financial institution which limits access to the data (e.g. ledger), now that the first financial institution no longer owns the debt it can be prevented from viewing payments received by the second financial institution, even though the debt is still stored in the same distribution ledger.

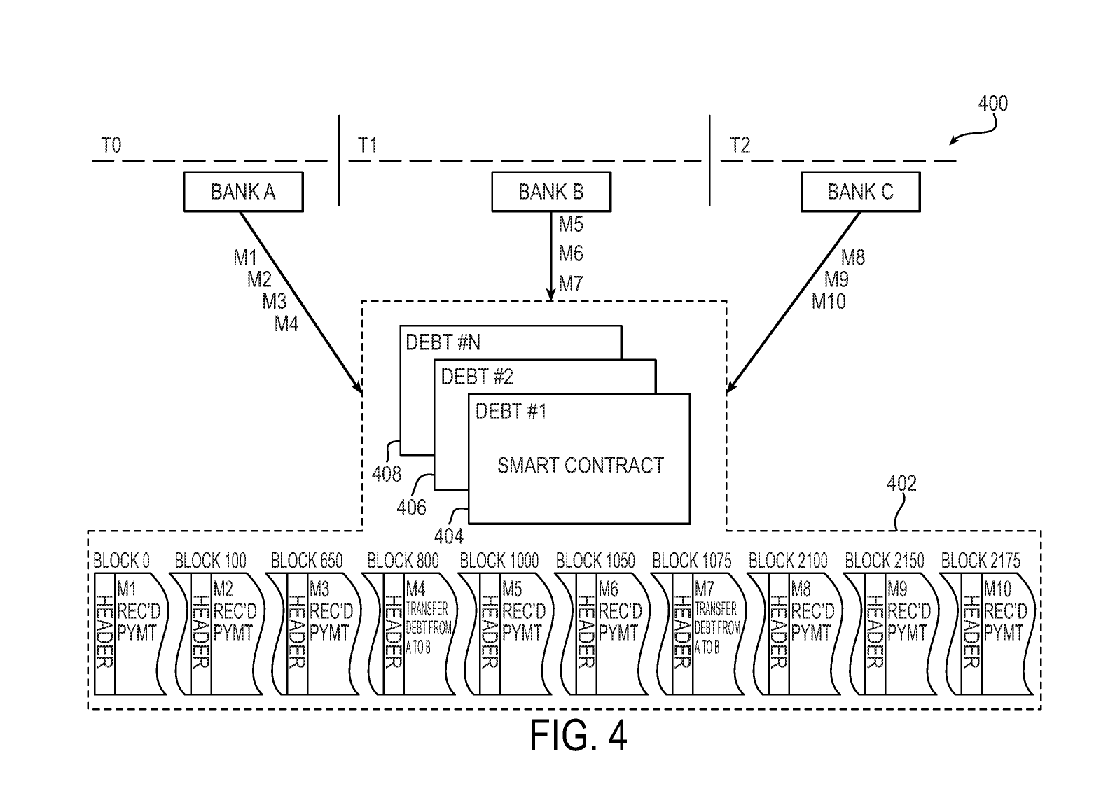

FIG. 4 is another example of a system 400 that uses a distributed ledger for tracking debt data that illustrates an example of a sequence that employs three financial institutions. The example illustrates three financial institutions, Bank A, Bank B, Bank C, that employ a distributed ledger 402 for the management of debts that comprise a first debt 404, a second debt 406, . . . , and an Nth debt 408, where N is an integer greater than two.

The following example will refer to the first debt 404, although those skilled in the art can readily appreciate the principles illustrated in this example may be applied to any debt in distribution ledger 402. Initially, at time TO the first debt 404 is owned by Bank A. Bank A sends messages M1, M2, and M3 for payments received that are stored in blocks 0, 100, and 650 respectively in distributed ledger 402. At approximately time T1, the first debt 404 is transferred from Bank A to Bank B. A message, M4, with data representative of the transfer is stored in block 800 of the distributed ledger 402. In the illustrated example, M4 is generated by Bank A, however, in other embodiments message M4 may be created by Bank B. Payments that are received by Bank B from approximately T1 to T2 are stored into the distribution ledger by Bank B in blocks 1000 and 1050 responsive to messages M5 and M6 respectively. At approximately time, T2, the debt is transferred from Bank B to Bank C. A record of the transfer is stored in Block 1075 in response to message M7 generated by Bank B. After time T2, Bank C receives payments on the debt indicated by messages M8-M10 stored in blocks 2100, 2150, and 2175 respectively.

In an example embodiment, messages M1-M3 are encrypted by a key associated with Bank A, thus Bank B and Bank C are unable to read messages. Message M4 may be encrypted by a key that is shared by Bank A and Bank B. In particular embodiments, Bank A may be provisioned with key that can allow Bank A to record payments received after T1 for a limited time period. Messages M5 and M6 are encrypted by a key associated with Bank B that prevent Bank A and Bank C from obtaining the data in these messages. Message M7 may be encrypted by a key shared by Bank B and Bank C to allow Bank B to record payments received for a limited time period after T2. Payments received by Bank C subsequent to time T2 are then recorded in the distributed ledger with a key associated with Bank C as indicated by messages M8-10 stored in blocks 2100, 2150, and 2175 respectively.

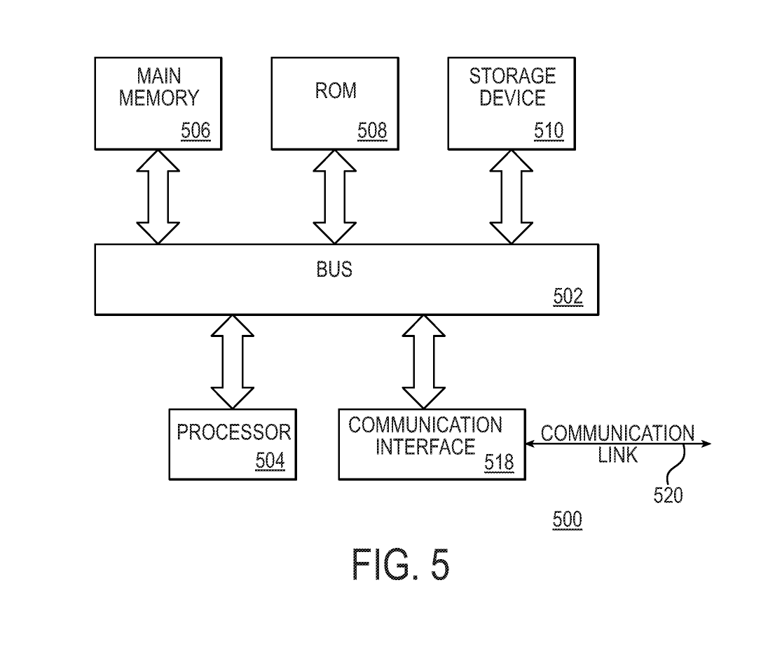

FIG. 5 is an example of a computer system 500 employed for implementing an example embodiment. Computer system 500 is suitable for implementing the functionality of logic 108 (FIG. 1) and 112 (FIG. 1).

Computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

An aspect of the example embodiment is related to the use of computer system 500 for using a distributed ledger to manage debt data. According to an example embodiment, using a distributed ledger to manage debt data is provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media. Non-volatile media includes for example optical or magnetic disks, such as storage device 510. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD, memory stick or any other memory chip or cartridge, or any other medium from which a computer can read.

In an example embodiment, storage device 510 may contain at least a portion of distributed ledger data. In particular embodiments, storage device 510 contains a copy of the distributed ledger.

Computer system 500 also includes a communication interface 518 coupled to bus 502. Communication interface 518 provides a two-way data communication coupling computer system 500 to a network link 520 that is connected to a network, such as a local area network, wireless network, and/or the Internet.

For example, communication interface 518 may be a local area network (LAN) card to provide a data communication connection to a compatible LAN. As another example, communication interface 518 may be an integrated services digital network (ISDN) card or a modem to provide a data communication connection to a corresponding type of telephone line. Wireless links may also be implemented. In any such implementation, communication interface 518 sends and receives electrical, electromagnetic, or optical signals that carry digital data streams representing various types of information.

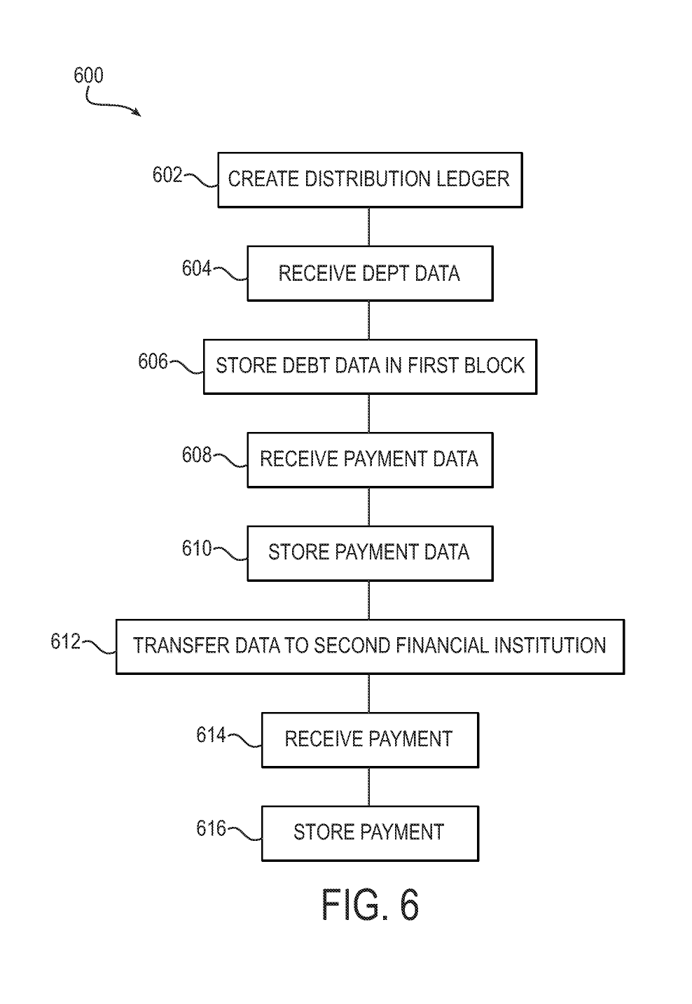

In view of the foregoing structural and functional features described above, a methodology 600 for tracking debt data in accordance with an example embodiment will be better appreciated with reference to FIG. 6. While, for purposes of simplicity of explanation, the methodology of FIG. 6 is shown and described as executing serially, it is to be understood and appreciated that the example embodiment is not limited by the illustrated order, as some aspects could occur in different orders and/or concurrently with other aspects that may or may not be shown and described herein. Moreover, not all illustrated features may be required to implement a methodology in accordance with an aspect of an example embodiment. The methodology described herein is suitably adapted to be implemented in hardware, software when executed by a processor, or a combination thereof.

At 602, a distributed ledger is created. In an example embodiment, the distributed ledger employs a blockchain protocol to store data. In particular embodiments, the blockchain is a private blockchain (e.g., parties that store data into the distributed ledger view their own data and data of other parties that the other parties have given permission). The blockchain may employ public key/private key encryption for sharing data.

At 604, data representative of a debt is received from a first of the plurality of financial institutions (e.g., Financial Institution 102 in FIG. 1). The data representative of a debt may be for any type of debt, including but not limited to Mortgages, Home Equity Loans, Vehicle Loans, Personal Loans, or Payday loans. The data representative of a debt may comprises data representative of an owner of the debt. In another example embodiment, the debt data may comprise data representative of a debtor. In yet another example embodiment, the data representative of a debt comprises a debt balance data. In still yet another example embodiment, the data representative of a debt comprises terms of the debt (e.g., interest rate, period, number of payments). In another example embodiment, the data representative of a debt comprises payment history data for the debt. In still yet another example embodiment, the data representative comprises status data, such as, for example, whether payments for the debt are current (no overdue payments), overdue, or severely overdue (e.g., longer than a predetermined time period where some action should be taken, such as sending a overdue notice to the debtor, charge an overdue fee, or initiate other collection activity). In particular embodiments, the debt data may comprise any combination of data representative of the owner of the debt, the debtor, debt balance data, terms of the debt, payment history data for the debt, or status data.

At 606, the data representative of the debt is stored in a first block in the distributed ledger. In particular embodiments, the debt data is stored employing a first key that is associated with the first financial institution.

At 608, payment information is received. In an example embodiment, the payment information includes, but is not limited to, date received and amount received.

At 610, the payment information is stored in a second block of the distributed ledger. Those skilled in the art should readily appreciate that because the distributed ledger (e.g, blockchain) is shared among several parties, the first block in the distributed ledger and the second block of the distributed ledger may not necessarily be adjacent to one another as blocks of data from other parties sharing the distributed ledger may have stored data during the intervening period between the time the first block was stored and the second block was store. In an example embodiment, the second block is encrypted with a key associated with the first financial institution.

Debts may be transferred between financial institutions. For example, the first financial institution may sell the debt to a second financial institution. As another example, the first financial institution may merge with a second financial institution.

At 612, data representative of a transfer of the debt from the first financial institution to a second financial institution (e.g., second financial institution 104 in FIG. 2.), is stored in a third block of the distributed ledger. The data may be stored by either party to the transfer or by a third party facilitating the transfer. In an example embodiment, a shared key is employed that can allow either party to view data representative of the transfer of the debt. In particular embodiments, keys with a limited time period may be employed that allow the first party to change balance data of the debt (for example if the first party receives a payment on the debt after the transfer) for a limited time period after the transfer. The data representative of the debt may include but is not limited to any one, (or combination of, prior and current debt owner data, debtor data, balance payment history, or debt terms. In particular embodiments, the data representative of the transfer is verified by verifying that the data indicating the transfer of the debt from the first financial institution to the second financial institution was signed by the first financial institution and the second financial institution.

At 614, a payment is received by the second financial institution. This payment is received after the transfer of the debt from the first financial institution to the second financial institution. The payment may be received by either the first or second financial institution.

At 616, data representative of the payment is stored in the distributed ledger encrypted with a second key that is associated with the second financial institution. The key may be a key that only the second financial institution can decrypt, or if the payment is received within a certain, predefined time period after the transfer, a key that is shared with the first financial institution.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. A method, comprising:
storing by logic associated with a first of a plurality of financial institutions that share a distributed ledger data representative of a debt in a first block in the distributed ledger, the data representative of the debt is encrypted with a first key associated with the first financial institution;
storing data representative of the first payment in a second block of the distributed ledger by the logic associated with the first of the plurality of financial institutions data representative of a first payment encrypted with the key associated with the first financial institution;
storing data representative of a transfer of the debt from the first financial institution to a second of the plurality of financial institution in a third block of the distributed ledger; and
storing by the logic associated with the second of the plurality of financial institutions the data representative of a second payment in a fourth block of the distributed ledger, the data representative of the second payment is encrypted with a key associated with the second financial institution.

2. The method according to claim 1, wherein the data representative of the transfer of the debt from the first of the plurality of financial institutions to the second of the plurality of financial institutions that is stored in the third block of the distributed ledger is encrypted by a key shared by first of the plurality of financial institutions and the second of the plurality of financial institutions.

3. The method according to claim 1, further comprising verifying the data indicating the transfer of the debt from the first of the plurality of financial institutions to the second of the plurality of financial institutions; and
wherein verifying the data indicating the transfer of the debt from the first of the plurality of financial institutions to the second of the plurality of financial institutions comprises verifying that the data indicating the transfer of the debt from the first of the plurality of financial institutions to the second of the plurality of financial institutions was signed by the first financial institution and the second of the plurality of financial institutions.

4. The method according to claim 1, wherein the data representative of the debt further comprises data representative of a debtor.

5. The method according to claim 1, wherein the data representative of the debt further comprises data representative of an owner of the debt, where the owner of the debt is the first of the plurality of financial institutions prior to the transfer of the debt.

6. The method according to claim 1, wherein the data representative of the debt further comprises a balance of debt.

7. The method according to claim 1, wherein the data representative of the debt further comprises terms of the debt.

8. The method according to claim 1, wherein the data representative of the debt further comprises payment history.

9. The method according to claim 1, wherein the data representative of the debt further comprises status of the debt selected from a group consisting of current and overdue

10. The method according to claim 1, wherein the data representative of the debt further comprises a status of debt selected from group consisting of current, overdue, and severely overdue.

11. A system, comprising:
a plurality of financial institutions having systems with logic that are operable to be in data communication with each other;
a distributed ledger that is in communication with the logic of the plurality of financial institutions;
logic associated with a first of the plurality of financial institutions is operable to receiving data representative of a debt;
the logic associated with the first of the plurality of financial institutions is operable to store the data representative of the debt in a first block in the distributed ledger, the data representative of the debt is encrypted with a first key associated with the first financial institution;
the logic associated with the first of the plurality of financial institutions is further operable to receive data representative of a first payment for the debt;
the logic associated with the first of the plurality of financial institutions is further operable to store data representative of the first payment and updated data representative of the debt in a second block of the distributed ledger, the data representative of the first payment encrypted with the key associated with the first financial institution;
the logic associated with the first of the plurality of financial institutions is further operable to provide data indicating a transfer of the debt from the first financial institution to a second financial institution;
the data representative of the debt is updated with the data representative of the transfer of the debt from the first financial institution to the second financial institution, the data representative of the debt is provided for storing in a third block of the distributed ledger by one of a group consisting of the logic associated with the first financial institution and the logic associated with the second financial institution;
the logic associated with the second financial institution is operable to receive data representative of a second payment for the debt; and
the logic associated with the second financial institution storing the data representative of the second payment in a fourth block of the distributed ledger, the data representative of the second payment is encrypted with a key associated with the second financial institution.

12. The system according to claim 11, the logic associated with the first financial institution and the logic associated with the second financial institution are operable to generate a shared key for storing the data representative of the transfer of the debt from the first financial institution to the second financial institution that is stored in the third block of the distributed ledger.

13. The system according to claim 11, further comprising logic for verifying the data indicating the transfer of the debt from the first financial institution to the second financial institution; and
wherein the logic for verifying the data indicating the transfer of the debt from the first financial institution to the second financial institution is operable to verify that the data indicating the transfer of the debt from the first financial institution to the second financial institution was signed by the first financial institution and the second financial institution.

14. The system according to claim 11, wherein the data representative of the debt further comprises data representative of a debtor.

15. The system according to claim 11, wherein the data representative of the debt further comprises data representative of an owner of the debt the owner of the debt is the first financial institution prior to the transfer of the debt.

16. The system according to claim 11, wherein the data representative of the debt further comprises a balance of debt.

17. The system according to claim 11, wherein the data representative of the debt further comprises terms of the debt.

18. The system according to claim 11, wherein the data representative of the debt further comprises payment history.

19. The system according to claim 11, wherein the data representative of the debt further comprises status of the debt selected from a group consisting of current and overdue

20. The system according to claim 11, wherein the data representative of the debt further comprises a status of debt selected from group consisting of current, overdue, and severely overdue.
